(19) United States
(12) Patent Application Publication
(10) Pub. No.: US 2015/0298207 A1
(43) Pub. Date: Oct. 22, 2015

(54) INDUCTIVE COIL DESIGNS FOR THE MELTING AND MOVEMENT OF AMORPHOUS METALS

(71) Applicant: Apple Inc., Cupertino, CA (US)

(72) Inventors: Christopher D. PREST, Cupertino, CA (US); Joseph C. POOLE, Cupertino, CA (US); Matthew S. SCOTT, Cupertino, CA (US); Dermot I. STRATTON, Cupertino, CA (US); Richard W. HELEY, Cupertino, CA (US); Duco B. PASMOOIJ, Cupertino, CA (US); Stephen P. ZADESKY, Cupertino, CA (US); Theodore A. WANIUK, Lake Forest, CA (US)

(21) Appl. No.: 14/397,590

(22) PCT Filed: May 4, 2012
(86) PCT No.: PCT/US2012/036641

§ 371 Date: Jun. 26, 2015

(51) Int. Cl. B22D 17/20; H05B 6/44; H05B 6/34; H05B 6/36; B22D 17/04; C22C 45/00

(52) U.S. Cl. CPC B22D 17/2038; B22D 17/04; B22D 17/203; C22C 45/00; H05B 6/34; H05B 6/367; H05B 6/44

(57) ABSTRACT

An apparatus with a vessel (20), a first induction source (30), and a second induction source (32) in the melt zone (12). The first induction source (30) is used to melt the material received in the vessel (20). The second induction source (32) is used to contain the material in a meltable form within the vessel (20) during melting. The coils (26) of each of the first and second induction sources (30, 32) can be arranged such that they intertwine in an alternate fashion or that they are in sets in a series. The coils (26) of the sources (30, 32) can also sequentially receive power such that the material is moved through the ejection path after melting and into an adjacent mold. The vessel (20) can be positioned along a horizontal axis (X). The apparatus can be used to melt and mold amorphous alloys; for example.

### FIELD

The present disclosure is generally related to a system and method for melting and molding meltable materials.

### BACKGROUND

When melting materials in an injection molding system, uniform temperatures in ranges appropriate to the meltable material should be implemented and maintained in order to produce quality molded parts. Maintaining meltable material within a melt zone during melting can improve quality.

### SUMMARY

A proposed solution according to embodiments herein for improving molded objects or parts is to use bulk-solidifying amorphous alloys.

One aspect of the disclosure provides an apparatus including a vessel for receiving meltable material; a first induction source that is positioned adjacent the vessel and configured to melt the material received in the vessel, and a second induction source that is positioned adjacent the vessel and configured to melt the material received in the vessel; wherein both of the first induction source and the second induction source have coils that are configured to be run at unsynchronized polarities to constrain the material being melted by an inductive field formed from the first and second induction sources during melting.

Another aspect of the disclosure provides an apparatus having a vessel for receiving meltable material; a first induction source that is positioned adjacent the vessel and configured to melt the material received in the vessel, and a second induction source that is positioned adjacent the first induction source and adjacent an ejection path of the vessel, the second induction source configured contain the material in a meltable form within the vessel during melting of the material.

Another aspect of the disclosure provides a method of melting a material in a meltable form including: providing an apparatus comprising a vessel for receiving meltable material; providing a material to be melted within the vessel; providing a first induction source positioned adjacent the vessel and configured to melt the provided material within in the vessel, providing a second induction source is positioned adjacent the first induction source and adjacent an ejection path of the vessel; applying a vacuum to the apparatus; melting the material under vacuum by applying power to the first induction source; and applying power to the second induction source during the melting of the material to contain the material in a meltable form within the vessel during the melting of the material.

Yet another aspect provides a method of moving material in a molten form including: providing an apparatus comprising a vessel for receiving meltable material; providing a material to be melted within the vessel; providing a first induction source positioned adjacent the vessel and configured to melt the provided material within in the vessel, providing a second induction source is positioned adjacent the first induction source and adjacent an ejection path of the vessel; applying a vacuum to the apparatus; melting the material under vacuum by applying power to at least the first induction source; and sequentially applying power to either or both of the first induction source and the second induction source after the melting of the material to move the material in a molten form through the vessel and its ejection path.

Other features and advantages of the present disclosure will become apparent from the following detailed description, the accompanying drawings, and the appended claims.

### BRIEF DESCRIPTION OF THE DRAWINGS

FIG. 1 provides a temperature-viscosity diagram of an exemplary bulk solidifying amorphous alloy.

FIG. 2 provides a schematic of a time-temperature-transformation (TTT) diagram for an exemplary bulk solidifying amorphous alloy.

FIG. 3 illustrates a schematic diagram of electromagnetic forces generated by inductive fields.

FIG. 4 illustrates a schematic diagram of an exemplary prior art system utilizing a gate for constraining material during melting.

FIG. 5 illustrates a schematic diagram of an exemplary system utilizing inductive fields to constrain material during melting in accordance with an embodiment of this disclosure.

FIG. 6 illustrates a schematic diagram of another implementation for the system of FIG. 5 with constraining induction coils in accordance with another embodiment of this disclosure.

FIG. 7 illustrates a schematic diagram of yet another implementation for the system of FIG. 5 for manipulating the inductive fields from a coil to move molten material in accordance with an embodiment of this disclosure.

FIG. 8 illustrates a schematic diagram of an exemplary system utilizing a single polarity to constrain material during melting in accordance with yet another embodiment of this disclosure.

### DETAILED DESCRIPTION

All publications, patents, and patent applications cited in this Specification are hereby incorporated by reference in their entirety.

The articles “a” and “an” are used herein to refer to one or to more than one (i.e., to at least one) of the grammatical object of the article. By way of example, “a polymer resin” means one polymer resin or more than one polymer resin. Any ranges cited herein are inclusive. The terms “substantially” and “about” used throughout this Specification are used to describe and account for small fluctuations. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

Bulk-solidifying amorphous alloys, or bulk metallic glasses (“BMG”), are a recently developed class of metallic materials. These alloys may be solidified and cooled at relatively slow rates, and they retain the amorphous, non-crystalline (i.e., glassy) state at room temperature. Amorphous alloys have many superior properties than their crystalline counterparts. However, if the cooling rate is not sufficiently high, crystals may form inside the alloy during cooling, so that the benefits of the amorphous state can be lost. For example, one challenge with the fabrication of bulk amorphous alloy parts is partial crystallization of the parts due to either slow cooling or impurities in the raw alloy material. As a high degree of amorphicity (and, conversely, a low degree of crystallinity) is desirable in BMG parts, there is a need to develop methods for casting BMG parts having controlled amount of amorphicity.

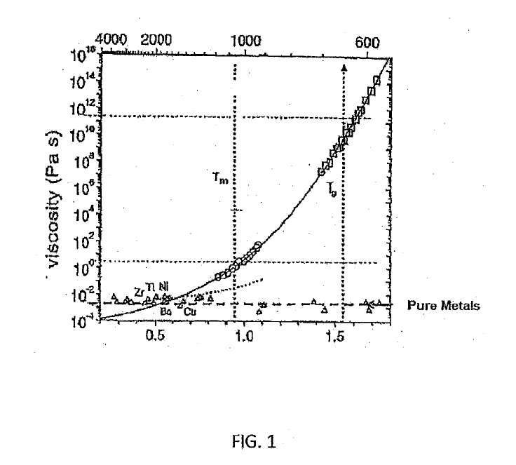

FIG. 1 (obtained from U.S. Pat. No. 7,575,040) shows a viscosity-temperature graph of an exemplary bulk solidifying amorphous alloy, from the VIT-001 series of Zr—Ti—Ni—Cu—Be family manufactured by Liquidmetal Technology. It should be noted that there is no clear liquid/solid transformation for a bulk solidifying amorphous metal during the formation of an amorphous solid. The molten alloy becomes more and more viscous with increasing undercooling until it approaches solid form around the glass transition temperature. Accordingly, the temperature of solidification front for bulk solidifying amorphous alloys can be around glass transition temperature, where the alloy will practically act as a solid for the purposes of pulling out the quenched amorphous sheet product.

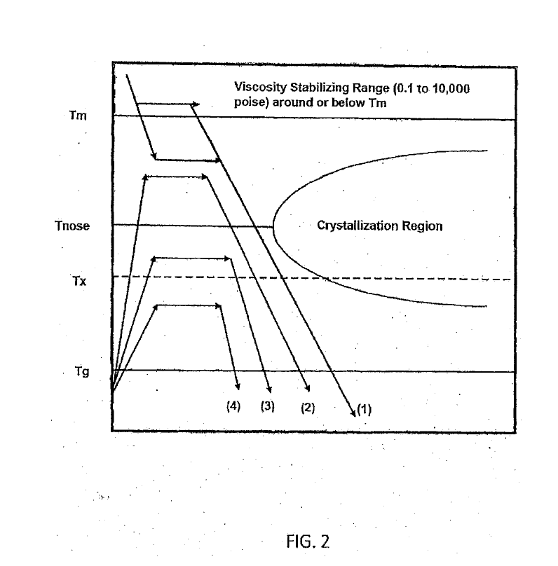

FIG. 2 (obtained from U.S. Pat. No. 7,575,040) shows the time-temperature-transformation (TTT) cooling curve of an exemplary bulk solidifying amorphous alloy, or TTT diagram. Bulk-solidifying amorphous metals do not experience a liquid/solid crystallization transformation upon cooling, as with conventional metals. Instead, the highly fluid, non crystalline form of the metal found at high temperatures (near a “melting temperature” Tm) becomes more viscous as the temperature is reduced (near to the glass transition temperature Tg), eventually taking on the outward physical properties of a conventional solid.

Even though there is no liquid/crystallization transformation for a bulk solidifying amorphous metal, a “melting temperature” Tm may be defined as the thermodynamic liquidus temperature of the corresponding crystalline phase. Under this regime, the viscosity of bulk-solidifying amorphous alloys at the melting temperature could lie in the range of about 0.1 poise to about 10,000 poise, and even sometimes under 0.01 poise. A lower viscosity at the “melting temperature” would provide faster and complete filling of intricate portions of the shell/mold with a bulk solidifying amorphous metal for forming the BMG parts. Furthermore, the cooling rate of the molten metal to form a BMG part has to such that the time-temperature profile during cooling does not traverse through the nose-shaped region bounding the crystallized region in the TTT diagram of FIG. 2. In FIG. 2, Tnose is the critical crystallization temperature Tx where crystallization is most rapid and occurs in the shortest time scale.

The supercooled liquid region, the temperature region between Tg and Tx is a manifestation of the extraordinary stability against crystallization of bulk solidification alloys. In this temperature region the bulk solidifying alloy can exist as a high viscous liquid. The viscosity of the bulk solidifying alloy in the supercooled liquid region can vary between 1012 Pa s at the glass transition temperature down to 105 Pa s at the crystallization temperature, the high temperature limit of the supercooled liquid region. Liquids with such viscosities can undergo substantial plastic strain under an applied pressure. The embodiments herein make use of the large plastic formability in the supercooled liquid region as a forming and separating method.

One needs to clarify something about Tx. Technically, the nose-shaped curve shown in the TTT diagram describes Tx as a function of temperature and time. Thus, regardless of the trajectory that one takes while heating or cooling a metal alloy, when one hits the TTT curve, one has reached Tx. In FIG. 1(b), Tx is shown as a dashed line as Tx can vary from close to Tm to close to Tg.

The schematic TTT diagram of FIG. 2 shows processing methods of die casting from at or above Tm to below Tg without the time-temperature trajectory (shown as (1) as an example trajectory) hitting the TTT curve. During die casting, the forming takes place substantially simultaneously with fast cooling to avoid the trajectory hitting the TTT curve. The processing methods for superplastic forming (SPF) from at or below Tg to below Tm without the time-temperature trajectory (shown as (2), (3) and (4) as example trajectories) hitting the TTT curve. In SPF, the amorphous BMG is reheated into the supercooled liquid region where the available processing window could be much larger than die casting, resulting in better controllability of the process. The SPF process does not require fast cooling to avoid crystallization during cooling. Also, as shown by example trajectories (2), (3) and (4), the SPF can be carried out with the highest temperature during SPF being above Tnose or below Tnose, up to about Tm. If one heats up a piece of amorphous alloy but manages to avoid hitting the TTT curve, you have heated “between Tg and Tm”, but one would have not reached Tx.

Typical differential scanning calorimeter (DSC) heating curves of bulk-solidifying amorphous alloys taken at a heating rate of 20 C/min describe, for the most part, a particular trajectory across the TTT data where one would likely see a Tg at a certain temperature, a Tx when the DSC heating ramp crosses the TTT crystallization onset, and eventually melting peaks when the same trajectory crosses the temperature range for melting. If one heats a bulk-solidifying amorphous alloy at a rapid heating rate as shown by the ramp up portion of trajectories (2), (3) and (4) in FIG. 2, then one could avoid the TTT curve entirely, and the DSC data would show a glass transition but no Tx upon heating. Another way to think about it is trajectories (2), (3) and (4) can fall anywhere in temperature between the nose of the TTT curve (and even above it) and the Tg line, as long as it does not hit the crystallization curve. That just means that the horizontal plateau in trajectories might get much shorter as one increases the processing temperature.

### Phase

The term “phase” herein can refer to one that can be found in a thermodynamic phase diagram. A phase is a region of space (e.g., a thermodynamic system) throughout which all physical properties of a material are essentially uniform. Examples of physical properties include density, index of refraction, chemical composition and lattice periodicity. A simple description of a phase is a region of material that is chemically uniform, physically distinct, and/or mechanically separable. For example, in a system consisting of ice and water in a glass jar, the ice cubes are one phase, the water is a second phase, and the humid air over the water is a third phase. The glass of the jar is another separate phase. A phase can refer to a solid solution, which can be a binary, tertiary, quaternary, or more, solution, or a compound, such as an intermetallic compound. As another example, an amorphous phase is distinct from a crystalline phase.

### Metal, Transition Metal, and Non-Metal

The term “metal” refers to an electropositive chemical element. The term “element” in this Specification refers generally to an element that can be found in a Periodic Table. Physically, a metal atom in the ground state contains a partially filled band with an empty state close to an occupied state. The term “transition metal” is any of the metallic elements within Groups 3 to 12 in the Periodic Table that have an incomplete inner electron shell and that serve as transitional links between the most and the least electropositive in a series of elements. Transition metals are characterized by multiple valences, colored compounds, and the ability to form stable complex ions. The term “nonmetal” refers to a chemical element that does not have the capacity to lose electrons and form a positive ion.

Depending on the application, any suitable nonmetal elements, or their combinations, can be used. The alloy (or “alloy composition”) can comprise multiple nonmetal elements, such as at least two, at least three, at least four, or more, nonmetal elements. A nonmetal element can be any element that is found in Groups 13-17 in the Periodic Table. For example, a nonmetal element can be any one of F, Cl, Br, I, At, O, S, Se, Te, Po, N, P, As, Sb, Bi, C, Si, Ge, Sn, Pb, and B. Occasionally, a nonmetal element can also refer to certain metalloids (e.g., B, Si, Ge, As, Sb, Te, and Po) in Groups 13-17. In one embodiment, the nonmetal elements can include B, Si, C, P, or combinations thereof Accordingly, for example, the alloy can comprise a boride, a carbide, or both.

A transition metal element can be any of scandium, titanium, vanadium, chromium, manganese, iron, cobalt, nickel, copper, zinc, yttrium, zirconium, niobium, molybdenum, technetium, ruthenium, rhodium, palladium, silver, cadmium, hafnium, tantalum, tungsten, rhenium, osmium, iridium, platinum, gold, mercury, rutherfordium, dubnium, seaborgium, bohrium, hassium, meitnerium, ununnilium, unununium, and ununbium. In one embodiment, a BMG containing a transition metal element can have at least one of Sc, Y, La, Ac, Ti, Zr, Hf, V, Nb, Ta, Cr, Mo, W, Mn, Tc, Re, Fe, Ru, Os, Co, Rh, Ir, Ni, Pd, Pt, Cu, Ag, Au, Zn, Cd, and Hg. Depending on the application, any suitable transitional metal elements, or their combinations, can be used. The alloy composition can comprise multiple transitional metal elements, such as at least two, at least three, at least four, or more, transitional metal elements.

The presently described alloy or alloy “sample” or “specimen” alloy can have any shape or size. For example, the alloy can have a shape of a particulate, which can have a shape such as spherical, ellipsoid, wire-like, rod-like, sheet-like, flake-like, or an irregular shape. The particulate can have any size. For example, it can have an average diameter of between about 1 micron and about 100 microns, such as between about 5 microns and about 80 microns, such as between about 10 microns and about 60 microns, such as between about 15 microns and about 50 microns, such as between about 15 microns and about 45 microns, such as between about 20 microns and about 40 microns, such as between about 25 microns and about 35 microns. For example, in one embodiment, the average diameter of the particulate is between about 25 microns and about 44 microns. In some embodiments, smaller particulates, such as those in the nanometer range, or larger particulates, such as those bigger than 100 microns, can be used.

The alloy sample or specimen can also be of a much larger dimension. For example, it can be a bulk structural component, such as an ingot, housing/casing of an electronic device or even a portion of a structural component that has dimensions in the millimeter, centimeter, or meter range.

### Solid Solution

[The term “solid solution” refers to a solid form of a solution. The term “solution” refers to a mixture of two or more substances, which may be solids, liquids, gases, or a combination of these. The mixture can be homogeneous or heterogeneous. The term “mixture” is a composition of two or more substances that are combined with each other and are generally capable of being separated. Generally, the two or more substances are not chemically combined with each other.

### Alloy

In some embodiments, the alloy composition described herein can be fully alloyed. In one embodiment, an “alloy” refers to a homogeneous mixture or solid solution of two or more metals, the atoms of one replacing or occupying interstitial positions between the atoms of the other; for example, brass is an alloy of zinc and copper. An alloy, in contrast to a composite, can refer to a partial or complete solid solution of one or more elements in a metal matrix, such as one or more compounds in a metallic matrix. The term alloy herein can refer to both a complete solid solution alloy that can give single solid phase microstructure and a partial solution that can give two or more phases. An alloy composition described herein can refer to one comprising an alloy or one comprising an alloy-containing composite.

Thus, a fully alloyed alloy can have a homogenous distribution of the constituents, be it a solid solution phase, a compound phase, or both. The term “fully alloyed” used herein can account for minor variations within the error tolerance. For example, it can refer to at least 90% alloyed, such as at least 95% alloyed, such as at least 99% alloyed, such as at least 99.5% alloyed, such as at least 99.9% alloyed. The percentage herein can refer to either volume percent or weight percentage, depending on the context. These percentages can be balanced by impurities, which can be in terms of composition or phases that are not a part of the alloy.

### Amorphous or Non-Crystalline Solid

An “amorphous” or “non-crystalline solid” is a solid that lacks lattice periodicity, which is characteristic of a crystal. As used herein, an “amorphous solid” includes “glass” which is an amorphous solid that softens and transforms into a liquid-like state upon heating through the glass transition. Generally, amorphous materials lack the long-range order characteristic of a crystal, though they can possess some short-range order at the atomic length scale due to the nature of chemical bonding. The distinction between amorphous solids and crystalline solids can be made based on lattice periodicity as determined by structural characterization techniques such as x-ray diffraction and transmission electron microscopy.

The terms “order” and “disorder” designate the presence or absence of some symmetry or correlation in a many-particle system. The terms “long-range order” and “short-range order” distinguish order in materials based on length scales.

The strictest form of order in a solid is lattice periodicity: a certain pattern (the arrangement of atoms in a unit cell) is repeated again and again to form a translationally invariant tiling of space. This is the defining property of a crystal. Possible symmetries have been classified in 14 Bravais lattices and 230 space groups.

Lattice periodicity implies long-range order. If only one unit cell is known, then by virtue of the translational symmetry it is possible to accurately predict all atomic positions at arbitrary distances. The converse is generally true, except, for example, in quasi-crystals that have perfectly deterministic tilings but do not possess lattice periodicity.

Long-range order characterizes physical systems in which remote portions of the same sample exhibit correlated behavior. This can be expressed as a correlation function, namely the spin-spin correlation function: G(x, x′)= [symbol] s(x), s(x′) [symbol] .

In the above function, s is the spin quantum number and x is the distance function within the particular system. This function is equal to unity when x=x′ and decreases as the distance |x−x′| increases. Typically, it decays exponentially to zero at large distances, and the system is considered to be disordered. If, however, the correlation function decays to a constant value at large |x−x′|, then the system can be said to possess long-range order. If it decays to zero as a power of the distance, then it can be called quasi-long-range order. Note that what constitutes a large value of |x−x′| is relative.

A system can be said to present quenched disorder when some parameters defining its behavior are random variables that do not evolve with time (i.e., they are quenched or frozen)—e.g., spin glasses. It is opposite to annealed disorder, where the random variables are allowed to evolve themselves. Embodiments herein include systems comprising quenched disorder.

The alloy described herein can be crystalline, partially crystalline, amorphous, or substantially amorphous. For example, the alloy sample/specimen can include at least some crystallinity, with grains/crystals having sizes in the nanometer and/or micrometer ranges. Alternatively, the alloy can be substantially amorphous, such as fully amorphous. In one embodiment, the alloy composition is at least substantially not amorphous, such as being substantially crystalline, such as being entirely crystalline.

In one embodiment, the presence of a crystal or a plurality of crystals in an otherwise amorphous alloy can be construed as a “crystalline phase” therein. The degree of crystallinity (or “crystallinity” for short in some embodiments) of an alloy can refer to the amount of the crystalline phase present in the alloy. The degree can refer to, for example, a fraction of crystals present in the alloy. The fraction can refer to volume fraction or weight fraction, depending on the context. A measure of how “amorphous” an amorphous alloy is can be amorphicity. Amorphicity can be measured in terms of a degree of crystallinity. For example, in one embodiment, an alloy having a low degree of crystallinity can be said to have a high degree of amorphicity. In one embodiment, for example, an alloy having 60 vol % crystalline phase can have a 40 vol % amorphous phase.

### Amorphous Alloy or Amorphous Metal

An “amorphous alloy” is an alloy having an amorphous content of more than 50% by volume, preferably more than 90% by volume of amorphous content, more preferably more than 95% by volume of amorphous content, and most preferably more than 99% to almost 100% by volume of amorphous content. Note that, as described above, an alloy high in amorphicity is equivalently low in degree of crystallinity. An “amorphous metal” is an amorphous metal material with a disordered atomic-scale structure. In contrast to most metals, which are crystalline and therefore have a highly ordered arrangement of atoms, amorphous alloys are non-crystalline. Materials in which such a disordered structure is produced directly from the liquid state during cooling are sometimes referred to as “glasses.” Accordingly, amorphous metals are commonly referred to as “metallic glasses” or “glassy metals.” In one embodiment, a bulk metallic glass (“BMG”) can refer to an alloy, of which the microstructure is at least partially amorphous. However, there are several ways besides extremely rapid cooling to produce amorphous metals, including physical vapor deposition, solid-state reaction, ion irradiation, melt spinning, and mechanical alloying. Amorphous alloys can be a single class of materials, regardless of how they are prepared.

Amorphous metals can be produced through a variety of quick-cooling methods. For instance, amorphous metals can be produced by sputtering molten metal onto a spinning metal disk. The rapid cooling, on the order of millions of degrees a second, can be too fast for crystals to form, and the material is thus “locked in” a glassy state. Also, amorphous metals/alloys can be produced with critical cooling rates low enough to allow formation of amorphous structures in thick layers—e.g., bulk metallic glasses.

The terms “bulk metallic glass” (“BMG”), bulk amorphous alloy (“BAA”), and bulk solidifying amorphous alloy are used interchangeably herein. They refer to amorphous alloys having the smallest dimension at least in the millimeter range. For example, the dimension can be at least about 0.5 mm, such as at least about 1 mm, such as at least about 2 mm, such as at least about 4 mm, such as at least about 5 mm, such as at least about 6 mm, such as at least about 8 mm, such as at least about 10 mm, such as at least about 12 mm. Depending on the geometry, the dimension can refer to the diameter, radius, thickness, width, length, etc. A BMG can also be a metallic glass having at least one dimension in the centimeter range, such as at least about 1.0 cm, such as at least about 2.0 cm, such as at least about 5.0 cm, such as at least about 10.0 cm. In some embodiments, a BMG can have at least one dimension at least in the meter range. A BMG can take any of the shapes or forms described above, as related to a metallic glass. Accordingly, a BMG described herein in some embodiments can be different from a thin film made by a conventional deposition technique in one important aspect—the former can be of a much larger dimension than the latter.

Amorphous metals can be an alloy rather than a pure metal. The alloys may contain atoms of significantly different sizes, leading to low free volume (and therefore having viscosity up to orders of magnitude higher than other metals and alloys) in a molten state. The viscosity prevents the atoms from moving enough to form an ordered lattice. The material structure may result in low shrinkage during cooling and resistance to plastic deformation. The absence of grain boundaries, the weak spots of crystalline materials in some cases, may, for example, lead to better resistance to wear and corrosion. In one embodiment, amorphous metals, while technically glasses, may also be much tougher and less brittle than oxide glasses and ceramics.

Thermal conductivity of amorphous materials may be lower than that of their crystalline counterparts. To achieve formation of an amorphous structure even during slower cooling, the alloy may be made of three or more components, leading to complex crystal units with higher potential energy and lower probability of formation. The formation of amorphous alloy can depend on several factors: the composition of the components of the alloy; the atomic radius of the components (preferably with a significant difference of over 12% to achieve high packing density and low free volume); and the negative heat of mixing the combination of components, inhibiting crystal nucleation and prolonging the time the molten metal stays in a supercooled state. However, as the formation of an amorphous alloy is based on many different variables, it can be difficult to make a prior determination of whether an alloy composition would form an amorphous alloy.

Amorphous alloys, for example, of boron, silicon, phosphorus, and other glass formers with magnetic metals (iron, cobalt, nickel) may be magnetic, with low coercivity and high electrical resistance. The high resistance leads to low losses by eddy currents when subjected to alternating magnetic fields, a property useful, for example, as transformer magnetic cores.

Amorphous alloys may have a variety of potentially useful properties. In particular, they tend to be stronger than crystalline alloys of similar chemical composition, and they can sustain larger reversible (“elastic”) deformations than crystalline alloys. Amorphous metals derive their strength directly from their non-crystalline structure, which can have none of the defects (such as dislocations) that limit the strength of crystalline alloys. For example, one modern amorphous metal, known as Vitreloy™, has a tensile strength that is almost twice that of high-grade titanium. In some embodiments, metallic glasses at room temperature are not ductile and tend to fail suddenly when loaded in tension, which limits the material applicability in reliability-critical applications, as the impending failure is not evident. Therefore, to overcome this challenge, metal matrix composite materials having a metallic glass matrix containing dendritic particles or fibers of a ductile crystalline metal can be used. Alternatively, a BMG low in element(s) that tend to cause embitterment (e.g., Ni) can be used. For example, a Ni-free BMG can be used to improve the ductility of the BMG.

Another useful property of bulk amorphous alloys is that they can be true glasses; in other words, they can soften and flow upon heating. This can allow for easy processing, such as by injection molding, in much the same way as polymers. As a result, amorphous alloys can be used for making sports equipment, medical devices, electronic components and equipment, and thin films. Thin films of amorphous metals can be deposited as protective coatings via a high velocity oxygen fuel technique.

A material can have an amorphous phase, a crystalline phase, or both. The amorphous and crystalline phases can have the same chemical composition and differ only in the microstructure—i.e., one amorphous and the other crystalline. Microstructure in one embodiment refers to the structure of a material as revealed by a microscope at 25× magnification or higher. Alternatively, the two phases can have different chemical compositions and microstructures. For example, a composition can be partially amorphous, substantially amorphous, or completely amorphous.

As described above, the degree of amorphicity (and conversely the degree of crystallinity) can be measured by fraction of crystals present in the alloy. The degree can refer to volume fraction of weight fraction of the crystalline phase present in the alloy. A partially amorphous composition can refer to a composition of at least about 5 vol % of which is of an amorphous phase, such as at least about 10 vol %, such as at least about 20 vol %, such as at least about 40 vol %, such as at least about 60 vol %, such as at least about 80 vol %, such as at least about 90 vol %. The terms “substantially” and “about” have been defined elsewhere in this application. Accordingly, a composition that is at least substantially amorphous can refer to one of which at least about 90 vol % is amorphous, such as at least about 95 vol %, such as at least about 98 vol %, such as at least about 99 vol %, such as at least about 99.5 vol %, such as at least about 99.8 vol %, such as at least about 99.9 vol %. In one embodiment, a substantially amorphous composition can have some incidental, insignificant amount of crystalline phase present therein.

In one embodiment, an amorphous alloy composition can be homogeneous with respect to the amorphous phase. A substance that is uniform in composition is homogeneous. This is in contrast to a substance that is heterogeneous. The term “composition” refers to the chemical composition and/or microstructure in the substance. A substance is homogeneous when a volume of the substance is divided in half and both halves have substantially the same composition. For example, a particulate suspension is homogeneous when a volume of the particulate suspension is divided in half and both halves have substantially the same volume of particles. However, it might be possible to see the individual particles under a microscope. Another example of a homogeneous substance is air where different ingredients therein are equally suspended, though the particles, gases and liquids in air can be analyzed separately or separated from air.

A composition that is homogeneous with respect to an amorphous alloy can refer to one having an amorphous phase substantially uniformly distributed throughout its microstructure. In other words, the composition macroscopically comprises a substantially uniformly distributed amorphous alloy throughout the composition. In an alternative embodiment, the composition can be of a composite, having an amorphous phase having therein a non-amorphous phase. The non-amorphous phase can be a crystal or a plurality of crystals. The crystals can be in the form of particulates of any shape, such as spherical, ellipsoid, wire-like, rod-like, sheet-like, flake-like, or an irregular shape. In one embodiment, it can have a dendritic form. For example, an at least partially amorphous composite composition can have a crystalline phase in the shape of dendrites dispersed in an amorphous phase matrix; the dispersion can be uniform or non-uniform, and the amorphous phase and the crystalline phase can have the same or a different chemical composition. In one embodiment, they have substantially the same chemical composition. In another embodiment, the crystalline phase can be more ductile than the BMG phase.

The methods described herein can be applicable to any type of amorphous alloy. Similarly, the amorphous alloy described herein as a constituent of a composition or article can be of any type. The amorphous alloy can comprise the element Zr, Hf, Ti, Cu, Ni, Pt, Pd, Fe, Mg, Au, La, Ag, Al, Mo, Nb, Be, or combinations thereof. Namely, the alloy can include any combination of these elements in its chemical formula or chemical composition. The elements can be present at different weight or volume percentages. For example, an iron “based” alloy can refer to an alloy having a non-insignificant weight percentage of iron present therein, the weight percent can be, for example, at least about 20 wt %, such as at least about 40 wt %, such as at least about 50 wt %, such as at least about 60 wt %, such as at least about 80 wt %. Alternatively, in one embodiment, the above-described percentages can be volume percentages, instead of weight percentages. Accordingly, an amorphous alloy can be zirconium-based, titanium-based, platinum-based, palladium-based, gold-based, silver-based, copper-based, iron-based, nickel-based, aluminum-based, molybdenum-based, and the like. The alloy can also be free of any of the aforementioned elements to suit a particular purpose. For example, in some embodiments, the alloy, or the composition including the alloy, can be substantially free of nickel, aluminum, titanium, beryllium, or combinations thereof. In one embodiment, the alloy or the composite is completely free of nickel, aluminum, titanium, beryllium, or combinations thereof.

For example, the amorphous alloy can have the formula (Zr, Ti)a(Ni, Cu, Fe)b(Be, Al, Si, B)c, wherein a, b, and c each represents a weight or atomic percentage. In one embodiment, a is in the range of from 30 to 75, b is in the range of from 5 to 60, and c is in the range of from 0 to 50 in atomic percentages. Alternatively, the amorphous alloy can have the formula (Zr, Ti)a(Ni, Cu)b(Be)c, wherein a, b, and c each represents a weight or atomic percentage. In one embodiment, a is in the range of from 40 to 75, b is in the range of from 5 to 50, and c is in the range of from 5 to 50 in atomic percentages. The alloy can also have the formula (Zr, Ti)a(Ni, Cu)b(Be)c, wherein a, b, and c each represents a weight or atomic percentage. In one embodiment, a is in the range of from 45 to 65, b is in the range of from 7.5 to 35, and c is in the range of from 10 to 37.5 in atomic percentages. Alternatively, the alloy can have the formula (Zr)a(Nb, Ti)b(Ni, Cu)c(Al)d, wherein a, b, c, and d each represents a weight or atomic percentage. In one embodiment, a is in the range of from 45 to 65, b is in the range of from 0 to 10, c is in the range of from 20 to 40 and d is in the range of from 7.5 to 15 in atomic percentages. One exemplary embodiment of the aforedescribed alloy system is a Zr—Ti—Ni—Cu—Be based amorphous alloy under the trade name Vitreloy™, such as Vitreloy-1 and Vitreloy-101, as fabricated by Liquidmetal Technologies, CA, USA. Some examples of amorphous alloys of the different systems are provided in Table 1 and Table 2.

TABLE 1
Additional Exemplary amorphous alloy compositions (atomic %)

| Alloy | Atm % | Atm % | Atm % | Atm % | Atm % | Atm % |
|---|---|---|---|---|---|---|
| 1 | Zr | Ti | Cu | Ni | Be | |
| | 41.20% | 13.80% | 12.50% | 10.00% | 22.50% | |
| 2 | Zr | Ti | Cu | Ni | Be | |
| | 44.00% | 11.00% | 10.00% | 10.00% | 25.00% | |
| 3 | Zr | Ti | Cu | Ni | Nb | Be |
| | 56.25% | 11.25% | 6.88% | 5.63% | 7.50% | 12.50% |
| 4 | Zr | Ti | Cu | Ni | Al | Be |
| | 64.75% | 5.60% | 14.90% | 11.15% | 2.60% | 1.00% |
| 5 | Zr | Ti | Cu | Ni | Al | |
| | 52.50% | 5.00% | 17.90% | 14.60% | 10.00% | |
| 6 | Zr | Nb | Cu | Ni | Al | |
| | 57.00% | 5.00% | 15.40% | 12.60% | 10.00% | |
| 7 | Zr | Cu | Ni | Al | | |
| | 50.75% | 36.23% | 4.03% | 9.00% | | |
| 8 | Zr | Ti | Cu | Ni | Be | |
| | 46.75% | 8.25% | 7.50% | 10.00% | 27.50% | |
| 9 | Zr | Ti | Ni | Be | | |
| | 21.67% | 43.33% | 7.50% | 27.50% | | |
| 10 | Zr | Ti | Cu | Be | | |
| | 35.00% | 30.00% | 7.50% | 27.50% | | |
| 11 | Zr | Ti | Co | Be | | |
| | 35.00% | 30.00% | 6.00% | 29.00% | | |
| 12 | Zr | Ti | Fe | Be | | |
| | 35.00% | 30.00% | 2.00% | 33.00% | | |
| 13 | Au | Ag | Pd | Cu | Si | |
| | 49.00% | 5.50% | 2.30% | 26.90% | 16.30% | |
| 14 | Au | Ag | Pd | Cu | Si | |
| | 50.90% | 3.00% | 2.30% | 27.80% | 16.00% | |
| 15 | Pt | Cu | Ni | P | | |
| | 57.50% | 14.70% | 5.30% | 22.50% | | |
| 16 | Zr | Ti | Nb | Cu | Be | |
| | 36.60% | 31.40% | 7.00% | 5.90% | 19.10% | |
| 17 | Zr | Ti | Nb | Cu | Be | |
| | 38.30% | 32.90% | 7.30% | 6.20% | 15.30% | |
| 18 | Zr | Ti | Nb | Cu | Be | |
| | 39.60% | 33.90% | 7.60% | 6.40% | 12.50% | |
| 19 | Cu | Ti | Zr | Ni | | |
| | 47.00% | 34.00% | 11.00% | 8.00% | | |
| 20 | Zr | Co | Al | | | |
| | 55.00% | 25.00% | 20.00% | | | |

TABLE 2
Exemplary amorphous alloy compositions

| Alloy | Atm % | Atm % | Atm % | Atm % | Atm % | Atm % | Atm% | Atm% |
|---|---|---|---|---|---|---|---|---|
| 1 | Fe | Mo | Ni | Cr | P | C | B | |
| | 68.00% | 5.00% | 5.00% | 2.00% | 12.50% | 5.00% | 2.50% | |
| 2 | Fe | Mo | Ni | Cr | P | C | B | Si |
| | 68.00% | 5.00% | 5.00% | 2.00% | 11.00% | 5.00% | 2.50% | 1.50% |
| 3 | Pd | Cu | Co | P | | | | |
| | 44.48% | 32.35% | 4.05% | 19.11% | | | | |
| 4 | Pd | Ag | Si | P | | | | |
| | 77.50% | 6.00% | 9.00% | 7.50% | | | | |
| 5 | Pd | Ag | Si | P | Ge | | | |
| | 79.00% | 3.50% | 9.50% | 6.00% | 2.00% | | | |
| 6 | Pt | Cu | Ag | P | B | Si | | |
| | 74.70% | 1.50% | 0.30% | 18.0% | 4.00% | 1.50% | | |

Other exemplary ferrous metal-based alloys include compositions such as those disclosed in U.S. Patent Application Publication Nos. 2007/0079907 and 2008/0118387. These compositions include the Fe(Mn, Co, Ni, Cu) (C, Si, B, P, Al) system, wherein the Fe content is from 60 to 75 atomic percentage, the total of (Mn, Co, Ni, Cu) is in the range of from 5 to 25 atomic percentage, and the total of (C, Si, B, P, Al) is in the range of from 8 to 20 atomic percentage, as well as the exemplary composition Fe48Cr15Mo14Y2C15B6. They also include the alloy systems described by Fe—Cr—Mo—(Y,Ln)-C—B, Co—Cr—Mo-Ln-C—B, Fe—Mn—Cr—Mo—(Y,Ln)-C—B, (Fe, Cr, Co)—(Mo,Mn)—(C,B)—Y, Fe—(Co,Ni)—(Zr,Nb,Ta)—(Mo,W)—B, Fe—(Al,Ga)—(P,C,B,Si,Ge), Fe—(Co, Cr,Mo,Ga,Sb)—P—B—C, (Fe, Co)—B—Si—Nb alloys, and Fe—(Cr—Mo)—(C,B)—Tm, where Ln denotes a lanthanide element and Tm denotes a transition metal element. Furthermore, the amorphous alloy can also be one of the exemplary compositions Fe80P12.5C5B2.5, Fe80P11C5B2.5Si1.5, Fe74.5Mo5.5P12.5C5B2.5, Fe74.5Mo5.5P11C5B2.5Si1.5, Fe70Mo5Ni5P12.5C5B2.5, Fe70Mo5Ni5P11C5B2.5Si1.5, Fe68Mo5Ni5Cr2P12.5C5B2.5, and Fe68Mo5Ni5Cr2P11C5B2.5Si1.5, described in U.S. Patent Application Publication No. 2010/0300148.

The amorphous alloys can also be ferrous alloys, such as (Fe, Ni, Co) based alloys. Examples of such compositions are disclosed in U.S. Pat. Nos. 6,325,868; 5,288,344; 5,368,659; 5,618,359; and 5,735,975, Inoue et al., Appl. Phys. Lett., Volume 71, p 464 (1997), Shen et al., Mater. Trans., JIM, Volume 42, p 2136 (2001), and Japanese Patent Application No. 200126277 (Pub. No. 2001303218 A). One exemplary composition is Fe72A15Ga2P11C6B4. Another example is Fe72A17Zr1 0Mo5W2B15. Another iron-based alloy system that can be used in the coating herein is disclosed in U.S. Patent Application Publication No. 2010/0084052, wherein the amorphous metal contains, for example, manganese (1 to 3 atomic %), yttrium (0.1 to 10 atomic %), and silicon (0.3 to 3.1 atomic %) in the range of composition given in parentheses; and that contains the following elements in the specified range of composition given in parentheses: chromium (15 to 20 atomic %), molybdenum (2 to 15 atomic %), tungsten (1 to 3 atomic %), boron (5 to 16 atomic %), carbon (3 to 16 atomic %), and the balance iron.

The amorphous alloy can also be one of the Pt- or Pd-based alloys described by U.S. Patent Application Publication Nos. 2008/0135136, 2009/0162629, and 2010/0230012. Exemplary compositions include Pd44.48Cu32.35Co4.05P19.11, Pd77.5A_{g}6Si9P7.5, and Pt74.7Cul.5Ag0.3P18B4Si1.5.

The aforedescribed amorphous alloy systems can further include additional elements, such as additional transition metal elements, including Nb, Cr, V, and Co. The additional elements can be present at less than or equal to about 30 wt %, such as less than or equal to about 20 wt %, such as less than or equal to about 10 wt %, such as less than or equal to about 5 wt %. In one embodiment, the additional, optional element is at least one of cobalt, manganese, zirconium, tantalum, niobium, tungsten, yttrium, titanium, vanadium and hafnium to form carbides and further improve wear and corrosion resistance. Further optional elements may include phosphorous, germanium and arsenic, totaling up to about 2%, and preferably less than 1%, to reduce melting point. Otherwise incidental impurities should be less than about 2% and preferably 0.5%.

In some embodiments, a composition having an amorphous alloy can include a small amount of impurities. The impurity elements can be intentionally added to modify the properties of the composition, such as improving the mechanical properties (e.g., hardness, strength, fracture mechanism, etc.) and/or improving the corrosion resistance. Alternatively, the impurities can be present as inevitable, incidental impurities, such as those obtained as a byproduct of processing and manufacturing. The impurities can be less than or equal to about 10 wt %, such as about 5 wt %, such as about 2 wt %, such as about 1 wt %, such as about 0.5 wt %, such as about 0.1 wt %. In some embodiments, these percentages can be volume percentages instead of weight percentages. In one embodiment, the alloy sample/composition consists essentially of the amorphous alloy (with only a small incidental amount of impurities). In another embodiment, the composition includes the amorphous alloy (with no observable trace of impurities).

In one embodiment, the final parts exceeded the critical casting thickness of the bulk solidifying amorphous alloys.

In embodiments herein, the existence of a supercooled liquid region in which the bulk-solidifying amorphous alloy can exist as a high viscous liquid allows for superplastic forming. Large plastic deformations can be obtained. The ability to undergo large plastic deformation in the supercooled liquid region is used for the forming and/or cutting process. As oppose to solids, the liquid bulk solidifying alloy deforms locally which drastically lowers the required energy for cutting and forming. The ease of cutting and forming depends on the temperature of the alloy, the mold, and the cutting tool. As higher is the temperature, the lower is the viscosity, and consequently easier is the cutting and forming.

Embodiments herein can utilize a thermoplastic-forming process with amorphous alloys carried out between Tg and Tx, for example. Herein, Tx and Tg are determined from standard DSC measurements at typical heating rates (e.g. 20° C./min) as the onset of crystallization temperature and the onset of glass transition temperature.

The amorphous alloy components can have the critical casting thickness and the final part can have thickness that is thicker than the critical casting thickness. Moreover, the time and temperature of the heating and shaping operation is selected such that the elastic strain limit of the amorphous alloy could be substantially preserved to be not less than 1.0%, and preferably not being less than 1.5%. In the context of the embodiments herein, temperatures around glass transition means the forming temperatures can be below glass transition, at or around glass transition, and above glass transition temperature, but preferably at temperatures below the crystallization temperature Tx. The cooling step is carried out at rates similar to the heating rates at the heating step, and preferably at rates greater than the heating rates at the heating step. The cooling step is also achieved preferably while the forming and shaping loads are still maintained.

### Electronic Devices

The embodiments herein can be valuable in the fabrication of electronic devices using a BMG. An electronic device herein can refer to any electronic device known in the art. For example, it can be a telephone, such as a cell phone, and a land-line phone, or any communication device, such as a smart phone, including, for example an iPhone™, and an electronic email sending/receiving device. It can be a part of a display, such as a digital display, a TV monitor, an electronic-book reader, a portable web-browser (e.g., iPad™), and a computer monitor. It can also be an entertainment device, including a portable DVD player, conventional DVD player, Blu-Ray disk player, video game console, music player, such as a portable music player (e.g., iPod™), etc. It can also be a part of a device that provides control, such as controlling the streaming of images, videos, sounds (e.g., Apple TV™), or it can be a remote control for an electronic device. It can be a part of a computer or its accessories, such as the hard drive tower housing or casing, laptop housing, laptop keyboard, laptop track pad, desktop keyboard, mouse, and speaker. The article can also be applied to a device such as a watch or a clock.

The methods, techniques, and devices illustrated herein are not intended to be limited to the illustrated embodiments.

The following embodiments are for illustrative purposes only and are not meant to be limiting.

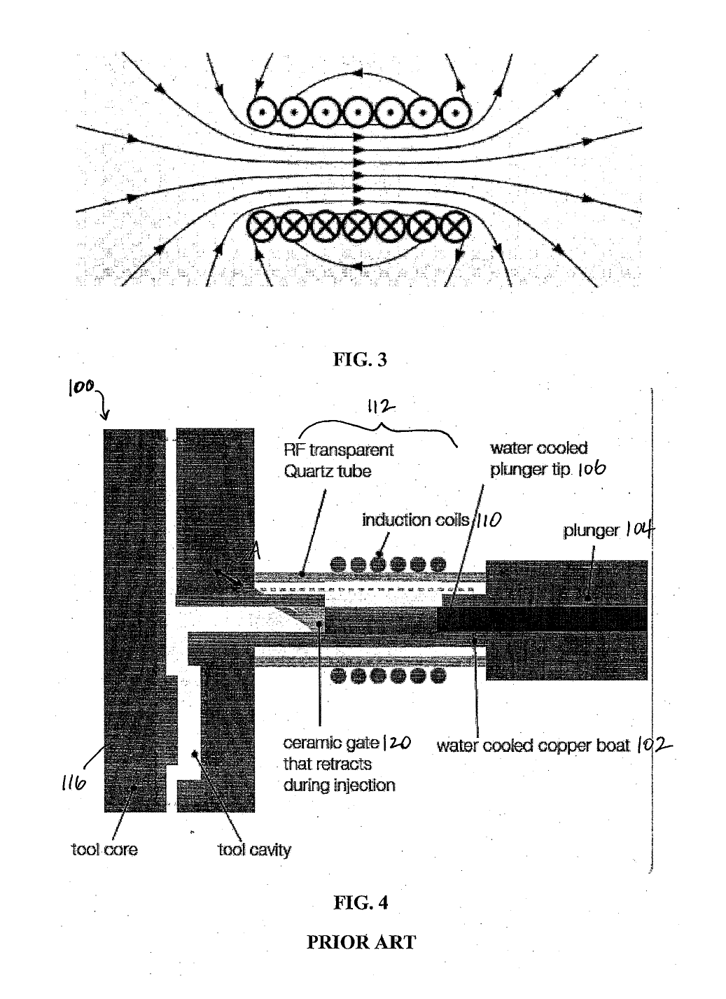

When melting materials in an injection molding system, the meltable material should be melted and maintained at a uniform temperature or range in order to produce quality molded parts. Maintaining meltable material within a melt zone during melting can improve the overall quality and final part. In particular, when using an induction source (that produces radiofrequency (RF) waves) for melting, the electromagnetic fields are concentrated in a designated area. For example, FIG. 3 illustrates an example of electromagnetic forces generated by inductive fields, e.g., as produced by coils. The coils are run at a very high power and very high frequency that will alternate back and forth (i.e., A/C current). Generally, such fields can be used to melt materials because such a source runs at a fast rate. It creates electromagnetic fields that can disturb meltable material within such fields. The material couples with these electro-magnetic forces and energy that gets absorbed through resistive losses in the material in that coupling will cause the temperature of the material to raise and to melt.

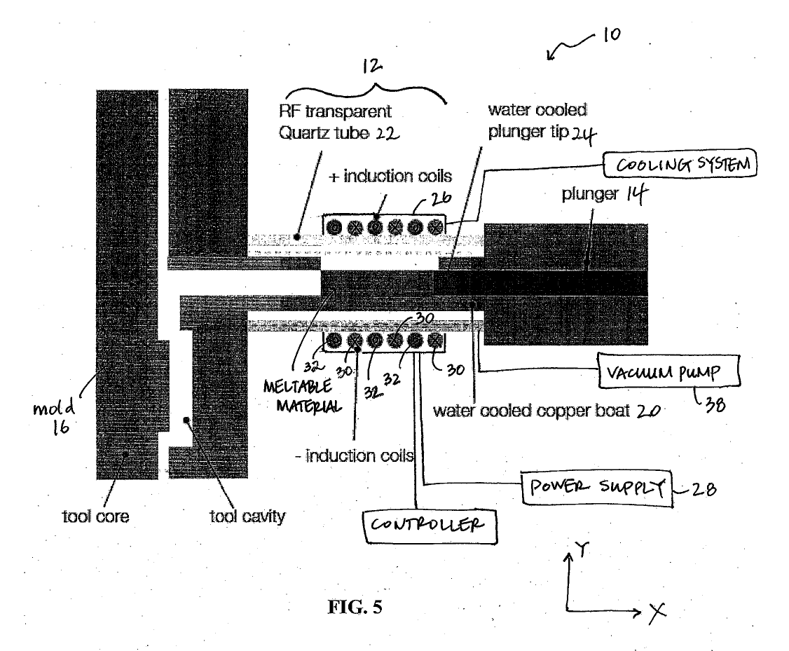

The likelihood of uniformly molded and formed parts depends upon the processes performed on the material in the injection molding system. Uniform heating of the meltable material and maintenance of temperature of molten material in an injection molding apparatus assists in forming a uniform molded part. The configuration of the vessel and melt zone can improve and provide such features. To contain material that is being melted and/or molten in such a system, devices are provided in the machine in the prior art. For example, such as shown in a prior art apparatus 100 in FIG. 4, a gate 120 is provided in the apparatus. The gate 120 is configured to constrain or contain molten material within a vessel 102 in a melt zone 112 (or induction zone) of the apparatus so that it stays in the inductive field of a single set of induction coils 110 during melting. On an opposite side, a plunger 104 is held in position to hold the material in the melt (or induction) zone using its tip 106. The gate can move between positions (as indicated by arrow A) so that it is in a first (active) position during melting to contain the material, and a second (retracted) position after melting to open the ejection path and allow for injection of the material into a cavity of a mold tool 116 (e.g., by moving the plunger through the vessel and towards the mold tool).

However, to accommodate such a mechanical device, parts of the machine or system itself requires manipulation and tooling so that it can effectively move in and out of the designated melt zone. The gate device and system must also be made from specific materials and configurations in order to withstand the heat from the induction sources and the contact with meltable materials while under vacuum. For example, problems have occurred because the temperatures that are required to melt materials such as amorphous alloys exceed operating temperatures of the materials they are in contact with. Although some devices, such as the vessel and plunger, can be actively cooled by a fluid from a secondary source, for example, the gate 120 (which can be formed from a material such as ceramic) is generally non-cooled because of the complexity of the design and system. Because it is not actively cooled, its temperature can increase to very high temperatures (e.g., upwards of 1100 to 1200 Centigrade). At these temperatures, at least a tip of the gate tends to physically degrade and break down, which compromises the stability of the entire system. Moreover, the gate can malfunction and/or fail, as it moves between positions and/or is in contact with the high temperature melted material.

Accordingly, in accordance with an embodiment, this disclosure provides an apparatus configured to use opposing inductive fields to constrain or contain the melt, removing the need for a gate. The removal of the gate simplifies the mechanical system and removes a costly component that is at high risk of failure being in contact with the high temperature melted material. In another embodiment, the inductive fields are configured to be manipulated such that they can move molten material along and through an ejection path of a vessel, so that the material can be molded. To provide such features, two induction sources can be used in the apparatus, for example.

FIG. 5 illustrates a schematic diagram of a cross-section of an exemplary system of this disclosure. As disclosed herein, an apparatus or a system (or a device or a machine) is configured to perform melting of and injection molding of material(s) (such as amorphous alloys). The apparatus is configured to process such materials or alloys by melting at higher melting temperatures before injecting the molten material into a mold for molding. As further described below, parts of the apparatus are positioned in-line with each other. In accordance with some embodiments, parts of the apparatus (or access thereto) are aligned on a horizontal axis.

More specifically, FIG. 5 illustrates an injection molding apparatus or system 10. In accordance with an embodiment, injection molding system 10 has a melt zone 12 configured to melt meltable material received therein, and at least one plunger rod 14 configured to eject molten material from melt zone 12 and into a mold 16 or mold tool. In an embodiment, at least plunger rod 14 and melt zone 12 are provided in-line and on a horizontal axis (e.g., X axis), such that plunger rod 14 is moved in a horizontal direction (e.g., along the X-axis) substantially through melt zone 12 to move the molten material into mold 16. The mold can be positioned adjacent to the melt zone. In an embodiment, the plunger rod 14 is a temperature regulated rod that includes one or more temperature regulating lines configured to flow a liquid (e.g., water, or other fluid) therein for regulating a temperature of at least a tip 24 of the plunger near an end of the plunger that contacts and moves molten material from melt zone 12 and into mold 16 (and can be used during molding). The cooling line(s) can assist in preventing excessive heating and melting of the tip and/or body of the plunger rod itself. Cooling line(s) may be connected to a cooling system configured to induce flow of a liquid in the vessel. The cooling line(s) may include one or more inlets and outlets for the liquid or fluid to flow therethrough. The inlets and outlets of the cooling lines may be configured in any number of ways and are not meant to be limited.

The material to be melted, or “meltable material,” can be received in the melt zone in any number of forms. For example, the meltable material may be provided into melt zone 12 in the form of an ingot (solid state), a semi-solid state, a slurry that is preheated, powder, pellets, etc. For explanatory purposes only, throughout this disclosure meltable material is described and illustrated as being in the form of an ingot that is in the form of a solid state feedstock; however, it should be noted that the material to be melted may be received in the injection molding system or apparatus 10 in a solid state, a semi-solid state, a slurry that is preheated, powder, pellets, etc., and that the form of the material is not limiting. In some embodiments, a loading port may be provided as part of injection molding system 10. The loading port can be a separate opening or area that is provided within the machine at any number of places. In an embodiment, a loading port may be a pathway through one or more parts of the machine. For example, the material (e.g., ingot) may be inserted in a horizontal direction into vessel 20 by plunger 14, or may be inserted in a horizontal direction from the mold side of the injection system 10 (e.g., through mold 16 and/or through a transfer sleeve (not shown) and into vessel 20). In other embodiments, the meltable material can be provided into melt zone 12 in other manners and/or using other devices (e.g., through an opposite end of the injection system).

Melt zone 12 includes a melting mechanism configured to receive meltable material and to hold the material as it is heated to a molten state. The melting mechanism may be in the form of a vessel 20, for example, that has a body for receiving meltable material and configured to melt the material therein. A vessel as used throughout this disclosure is a container made of a material employed for heating substances to high temperatures. For example, in an embodiment, the vessel may be a crucible, such as a boat style crucible. In an embodiment, vessel 20 is a cold hearth melting device that is configured to be utilized for meltable material(s) while under a vacuum (e.g., applied by a vacuum device 38 or pump). In some embodiments, the vessel is a temperature regulated vessel. Vessel 20 may also have an inlet for inputting material (e.g., feedstock) into a receiving or melting portion of its body. In some embodiments, the body of vessel 20 comprises a substantially U-shaped structure. However, the shape is not meant to be limiting. Vessel 20 can comprise any number of shapes or configurations. The body of the vessel has a length and can extend in a longitudinal and horizontal direction, such that molten material is removed horizontally therefrom through an ejection path of the vessel using plunger 14. The material for heating or melting may be received in a melting portion of the vessel. For example, the melting portion has a surface for receiving material. Vessel 20 may receive material (e.g., in the form of an ingot) in its melting portion using one or more devices of an injection system for delivery (e.g., loading port and plunger).

The body of vessel 20 may be configured to receive the plunger rod 14 therethrough in a horizontal direction to move the molten material through its ejection path after melting. That is, in an embodiment, the melting mechanism is on the same axis as the plunger rod, and the body can be configured and/or sized to receive at least part (e.g., tip 24) of the plunger rod. Thus, plunger rod 14 can be configured to move molten material (after heating/melting) from the vessel by moving substantially through vessel 20, and into mold 16. Referencing the illustrated embodiment of system 10 in FIG. 5, for example, plunger rod 14 would move in a horizontal direction from the right towards the left, through vessel 20 and its ejection path (the ejection side or path being on the left side in FIG. 5, and the opposite side of the vessel being a plunger insertion point), moving and pushing the molten material towards and into mold 16. In an embodiment, the plunger rod 14 can also be used to restrict the opposite side of the vessel (opposite of the ejection path, at a plunger insertion point) and contain the material in a meltable form within the vessel during melting of the material.

The “ejection path” as used throughout this disclosure and in any of the embodiments is the path at which molten material is output or ejected from the vessel in its molten state (i.e., after melting). In some cases, this may also be referred to as the injection path into a mold, i.e., the part at which molten material moves from the vessel and is injected into the mold for molding. Although ejection is used throughout this disclosure to describe such a path, it should be understood that such a term is not limiting and that is refers to the path in which the molten material moves from the melt zone or vessel and into the mold.

To heat melt zone 12 and melt the meltable material received in vessel 20, injection system 10 also includes at least one heat source that is used to heat and melt the meltable material. In the illustrated embodiments herein, at least two heat sources are used: The vessel is configured to be heated such that the material received therein is melted. Heating is accomplished using, for example, induction sources 26 positioned within melt zone 12 that is configured to melt the meltable material. Each induction source is configured to inductively melt a material, such as a metal or alloy ingot, within a melting portion of a vessel by supplying power to the induction coils. In an embodiment, the induction sources 26 are positioned adjacent vessel 20. For example, induction sources 26 may be in the form of coils positioned in a helical pattern substantially around a length of the vessel body (shown in cross section here). An RF transparent tube 22 can be provided between vessel 20 and induction coils 26. Tube 22 may be made of quartz, for example. Generally, such a tube 22 is known in the art and not described in great detail herein. Accordingly, the system 10 is configured to inductively melt a meltable material (e.g., an inserted ingot) within vessel 20 by supplying power (e.g., current) to induction sources/coils 26, using a power supply or source 28. This produces a localized oscillating electromagnetic field. Thus, the melt zone 12 can include an induction zone. Induction coils 26 are configured to heat up and melt any material that is contained by vessel 20 without melting and wetting vessel 20. Induction coils 26 emit localized radiofrequency (RF) waves towards vessel 20, such as in the configuration shown in FIG. 3). The localized electromagnetic field dissipates energy (heat) in the material/alloy by the material's resistance to eddy current propagation. The body of vessel 20 and coils 26 may be configured to be positioned longitudinally in a horizontal direction along a horizontal axis (e.g., X axis). Further description regarding each of the induction sources 26 and related embodiments is shown and provided with respect to FIGS. 5, 6 and 7 below.

In one embodiment, the vessel 20 is a temperature regulated vessel. Such a vessel may include one or more temperature regulating lines configured to flow a liquid (e.g., water, or other fluid) therein for regulating a temperature of the body of vessel 20 during melting of material received in the vessel (e.g., to force cool the vessel). Such a forced-cool crucible can also be provided on the same axis as the plunger rod. The cooling line(s) can assist in preventing excessive heating and melting of the body of the vessel 20 itself. Cooling line(s) may be connected to a cooling system configured to induce flow of a liquid in the vessel. The cooling line(s) may include one or more inlets and outlets for the liquid or fluid to flow therethrough. The inlets and outlets of the cooling lines may be configured in any number of ways and are not meant to be limited. The cooling liquid or fluid may be configured to flow through the cooling line(s) during melting of the meltable material, when induction sources 26 are powered.

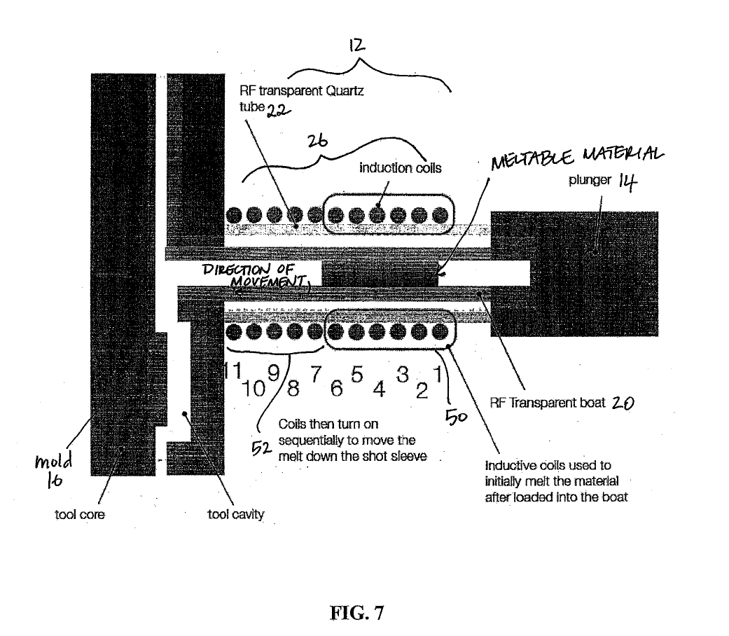

In one embodiment, after the material is melted in the vessel 20, plunger 14 may be used to force the molten material from vessel 20 and into a mold 16 for molding into an object, a part or a piece. In another embodiment, discussed with reference to FIG. 7 below, the induction sources 26 may be used to move the molten material through vessel 20 and its ejection path towards mold 16. In instances wherein the meltable material is an alloy, such as an amorphous alloy, the mold 16 is configured to form a molded bulk amorphous alloy object, part, or piece. Mold 16 has an inlet for receiving molten material therethrough. An output of the vessel 20 and an inlet of the mold 16 can be provided in-line and on a horizontal axis such that molten material is moved in a horizontal direction through a body of the vessel and injected into a cavity of the mold 16 via its inlet.

As previously noted, systems such as injection molding system 10 that are used to mold materials such as metals or alloys may implement a vacuum when forcing molten material into a mold or die cavity. Injection molding system 10 can further includes at least one vacuum source 38 or pump that is configured to apply vacuum pressure to at least melt zone 12 and mold 16. The vacuum pressure may be applied to at least the parts of the injection molding system 10 used to melt, move or transfer, and mold the material therein. For example, the vessel 20, and plunger rod 14 may all be under vacuum pressure and/or enclosed in a vacuum chamber.

In an embodiment, mold 16 is a vacuum mold that is an enclosed structure configured to regulate vacuum pressure therein when molding materials. For example, in an embodiment, vacuum mold 16 comprises a first plate (also referred to as an “A” mold or “A” plate), a second plate (also referred to as a “B” mold or “B” plate) positioned adjacently (respectively) with respect to each other. The first plate and second plate generally each have a mold cavity associated therewith for molding melted material therebetween. The cavities are configured to form a single cavity to mold molten material received therebetween. The mold cavities may include a part cavity for forming and molding a part therein.

Molten material is pushed or moved in a horizontal direction into the mold cavity(ies) via the inlet (e.g., in a first plate) and between the first and second plates. During molding of the material, the at least first and second plates are configured to substantially eliminate exposure of the material (e.g., amorphous alloy) therebetween to at least oxygen and nitrogen. Specifically, a vacuum is applied such that atmospheric air is substantially eliminated from within the plates and their cavities. A vacuum pressure is applied to an inside of vacuum mold 16 using at least one vacuum source 38 that is connected via vacuum lines. For example, the vacuum pressure or level on the system can be held between 1×10-1 to 1×10-4 Torr during the melting and subsequent molding cycle. In another embodiment, the vacuum level is maintained between 1×10-2 to about 1×10-4 Torr during the melting and molding process. Of course, other pressure levels or ranges may be used, such as 1×10-9 Torr to about 1×10-3 Torr, and/or 1×10-3 Torr to about 0.1 Torr. In an embodiment, an ejector mechanism (not shown) is configured to eject molded (amorphous alloy) material (or the molded part) from the mold cavity between the first and second plates of mold 16 (when mold is opened). The ejection mechanism is associated with or connected to an actuation mechanism (not shown) that is configured to be actuated in order to eject the molded material or part (e.g., after first and second parts and are moved horizontally and relatively away from each other, after vacuum pressure between at least the plates is released).

Any number or types of molds may be employed in the apparatus 10. For example, any number of plates may be provided between and/or adjacent the first and second plates to form the mold. Molds known as “A” series, “B” series, and/or “X” series molds, for example, may be implemented in injection molding system/apparatus 10.

Referring now more specifically to the induction sources 26, in accordance with an embodiment, more than one induction source is provided in the melt zone to improve melting in system 10. That is, two or more induction sources can be used. The induction sources may include a configuration of coils that are individually or collectively powered. Each induction source may be powered by the same or separate power sources (e.g., such as power source 28).

FIG. 5 illustrates a first induction source 30 and a second induction source 32 used as the induction sources 26 for melting in melt zone 12 in system 10, in accordance with an embodiment. Although two sets of induction coils are shown, more than two can also be used in system 10. First induction source 30 is positioned adjacent the vessel and configured to melt the material received in the vessel. Second induction source 32 is also positioned adjacent the vessel and configured to melt the material received in the vessel. Both of first induction source 30 and second induction source 32 comprise coils that are positioned in an alternating fashion (e.g., intertwined) such that each coil from first induction source 30 is adjacent a coil from second induction source 32. That is, as shown in FIG. 5, coils from first induction source 30 (marked with an “∘”) are placed adjacent to coils from second induction source 32 (marked with an “×”), and vice versa. Every other coil belongs to a different, respective induction source. By putting each coil of the at least two separate sets of coils in series, the electromagnetic fields of the inductive coils is used to constrain melted material. More specifically, the coils of first and second induction sources 30 and 32 are configured to run independently of each other; thus, the coils of first and second induction sources 30 and 32 are configured to be run at unsynchronized polarities by alternating the currents to constrain the material being melted in melt zone 12 by an inductive field formed from the first and second induction sources 30 and 32 during melting (when the induction sources 30 and 32 are powered by power source 28). The frequency at which the coils are being operated can also be alternated. This allows the coils of first induction source 30 and the coils of second induction source 32 to operate alternately back and forth, thereby countering one force with another. The coils of sources 30 and 32 can both be operating in positive, for example, so that the opposing forces in the induction field are used to physically constrain the melt. In addition, the frequency of shifting back and forth between the forces from each induction source 30 and 32 causes the material to heat until it reaches its melt temperature so that it is molten. Thus, the coils from both sources 30 and 32 are used both for heating and for constraining the material.

In an embodiment, the phases of the coils of the induction sources 30 and 32 can be timed so that the induction fields would not counter the electromagnetic fields of the other, while still allowing the material to be melted. The phase shift of the coils can also be tuned based on the sources being used such that there is enough heating power out of the induction forces being sent to the meltable material while also counter acting the forces in an opposite direction so that physical movement of the melting material is reduced or prevented.

In an embodiment, frequencies in the range of and including approximately 1 kHz to approximately 100 kHz may be applied by the coils to the material for either or both melting and constraining. The frequencies may be separately controlled and may be varied, for example, before, during, and/or after the melting process. One example is further described below.

Accordingly, by alternating the coils from multiple induction sources such as shown in FIG. 5, the material can be controlled and maintained into a more condensed geography, i.e., within the vessel.

In some cases, it may be desirable to adjust the frequency at which polarities are switched (i.e., current) backwards and forwards so that first and second induction sources may be used more efficiently. So, rather that alternating coils in an intertwining fashion, two separate, decoupled coils can be used to implement more control of the material in molten form, and for efficient heating. Specifically, one set of coils can be used for heating, while another is used for constraining.

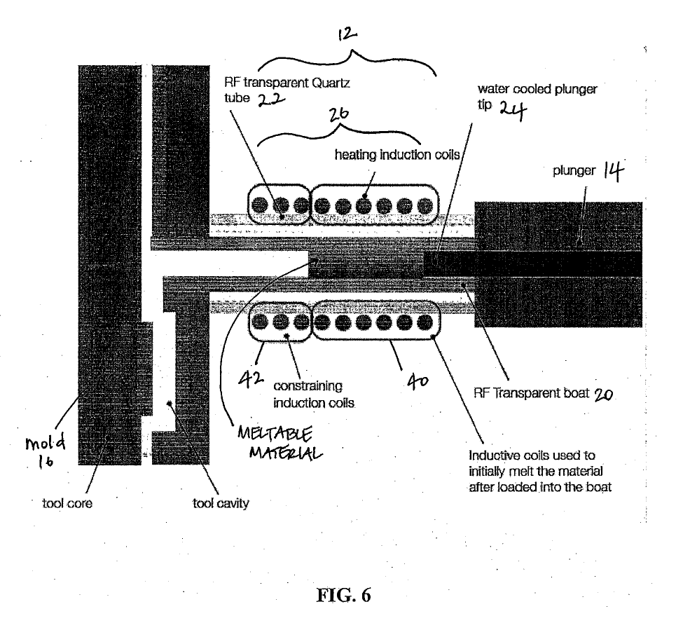

FIG. 6 illustrates such an embodiment for using inductive fields from multiple sources to constrain and/or contain the material with melt zone 12 of the system during melting. It should be noted that similar reference numbers are used in FIG. 6 to represent features that were described above with reference to FIG. 5, and therefore their description is not repeated here. Additionally, some features as shown and described with respect to the disclosed system 10 in FIG. 5 have been removed for simplicity only; that is, it should be noted that any of the features described with reference to FIG. 5 may also be included in the embodiment illustrated in FIG. 6. In this embodiment, two sets of induction coils are provided in series as the induction sources 26 in the melt zone 12 of the machine. A first induction source 40 is positioned adjacent vessel 20 at or near a first end (e.g., the plunger insertion end). First induction source 40 includes induction coils that are used to heat and initially melt material that is loaded into or received in the vessel 20. In an embodiment, first induction source 40 may extend substantially along a length of the vessel 20. A second induction source 42 is positioned adjacent first induction source 40 and at least adjacent an ejection path (i.e., closer to mold 16) of vessel 20. The coils of course 40 and 42 are provided as sets in series. Second induction source 42 includes induction coils that may be positioned next to the coils of first induction source 40, at or near the ejection end of the vessel 20, and/or extend beyond the end of the vessel 20 (e.g., along the length of transparent tube 22). Second induction source 42 is configured contain the material in a meltable or molten form within vessel 20 during melting of the material.

First induction source 40 acts as a primary source for heating and melting material received in the vessel 20 at a first frequency. Meanwhile, second induction source 42 can be tuned to a second frequency (which may or may not be different than the first frequency at which first induction source is operating) and acts as a means for constraining the material within the melt zone 12. In an embodiment, the frequency at which second induction source 42 operates is configured to move or stir material in molten form by creating a force effect on it in the induction zone through heating. Thus, the second frequency of second induction source 42 may be higher than the frequency of the first induction source 40. Alternatively, the second frequency can be approximately equal to or lower than the first frequency.

As described further below with reference to FIG. 7, the electromagnetic forces generated by the inductive power can be used as at least part of the method that moves the material in its molten form through the vessel and towards the mold. Such forces can be controlled and/or altered via a controller of the induction sources, for example, during different times in the melting and molding process.

For example, in an embodiment, the frequency used for heating and melting may be provided in a range between and including approximately 10 kHz to approximately 100 kHz. In an embodiment, the frequency for constraining/holding the material and/or moving the material may be provided in a range between and including approximately 0.05 kHz to approximately 20 kHz. Such ranges, however, are exemplary only and not limiting. Moreover, as previously noted, the frequencies can be altered and/or varied.

By putting at least two separate sets of coils in series (first induction source 40 having one set of coils, second induction source 42 having a second, separate set of coils), and operating them accordingly, the electromagnetic fields of the inductive coils is used to constrain melted material. In an embodiment, the coils of the first and second induction sources 40 and 42 are configured to run at unsynchronized polarities to constrain the material being melted by the inductive field formed when the induction sources 40 and 42 are powered and used for melting. The phases of the coils can be timed so that the induction fields would not counter the electromagnetic fields of the other, while still allowing the material to be melted.

By having two independently controlled sets of coils in first and second induction sources 40 and 42, the energy and phase shift can be more accurately controlled in the melt zone 12. In some cases, such as when the power to each of the induction sources is different, the force on the molten material can be greater on one side than on another, forming a net result in force in a single direction. This can be used to move the molten material within or through the vessel.

In the embodiment shown in FIG. 7, an inductive field is used to move or push molten material from melt zone 12 and towards mold 16 (in this illustration from center/right to left) (i.e., from a first location or point to a second location or point). That is, the series of electromagnetic fields of the coils of inductive sources are controlled so that they transport molten material towards (and into) mold 16. The coils of the sources can also continue to heat the molten material while it is in transport up to the point of injection into mold 16. This can reduce or prevent cooling of the molten material and thus formation of crystals or skull material (which degrades the quality of a molded part).

It should be noted that similar reference numbers are used in FIG. 7 to represent features that were described above with reference to FIG. 5, and therefore their description is not repeated here. Additionally, some features as shown and described with respect to the disclosed system 10 in FIG. 5 or FIG. 6 have been removed for simplicity only; that is, it should be noted that any of the features described with reference to FIG. 5 or FIG. 6 may also be included in the embodiment illustrated in FIG. 7. As shown in FIG. 7, two sets of induction coils are provided in series as the induction sources 26 in the melt zone 12 of the machine. A first induction source 50 is positioned adjacent vessel 20 at least at or near a first end (e.g., the plunger insertion end). First induction source 50 includes induction coils that are used to heat and initially melt material that is loaded into or received in the vessel 20. In an embodiment, first induction source 50 may extend substantially along a length of the vessel 20. A second induction source 52 is positioned adjacent first induction source 50 and at least adjacent an ejection path (i.e., closer to mold 16) of vessel 20. The coils of the sources 50 and 52 are provided as sets in series. Second induction source 52 includes induction coils that may be positioned next to the coils of first induction source 50, at or near the ejection end of the vessel 20, and/or extend beyond the end of the vessel 20 (e.g., along the length of transparent tube 22). More specifically, in this embodiment, the coils of second induction source 52 are configured to extend substantially along the entire travel path of the molten material within tube 22.

In an embodiment, second induction source 52 is configured contain the material in a meltable or molten form within vessel 20 during melting of the material (such as described above with reference to FIG. 6). However, second induction source 52 does not necessarily need to be activated in such a manner. Second induction source 52 is at least configured to be used to move material in molten form through and/or from vessel 20 and through its ejection path and towards mold 16. To do this, first and second inductions sources are configured such that power is sequentially applied to either or both thereof after melting of the material. In an embodiment, the different coils of the sources 50 and 52 are designed to be turned on and turned off sequentially such that the fields physically force the molten material to move in the direction towards mold 16 (in this case, towards the left).

In an embodiment, each coil of the first induction source and the second induction is configured to be powered separately. Thus, the system can be designed such each coil itself has power sequentially applied thereto. For example, each coil from the first induction source (labeled in FIG. 7 as coils 1, 2, 3, 4, 5, and 6) can sequentially receive power (e.g., coil 1, then coil 2, etc.), and, thereafter, each coil from the second induction source (labeled in FIG. 7 as coils 7, 8, 9, 10, and 11) can sequentially receive power to move the material in molten form through the ejection path and towards mold 16. The power supply to the coils and/or sets can be timed. Accordingly, a timed series of power to the induction coils may be used to control the generated electromagnetic field to push molten material (e.g., molten amorphous metal) into cavity of mold 16.

In an embodiment, the sequential fields are designed to work in conjunction with a separate method to provide an appropriate packing pressure to keep the molten material in the mold and allow it to cool and hardened. Such methods are not discussed in detail herein.

The device and method shown in FIG. 7 allows for continually maintaining a temperature of the material in molten form as it is first melting and then transporting from the vessel 20 to mold 16. It also provides a non-mechanical means for moving and pushing molten material. This assists in removing any cooled or frozen material and thus the formation of crystals or skull parts (e.g., by moving and mixing the material while continuously heating it along the travel path). Thus, it allows it for more, a more uniform temperature distribution throughout the entire melt, resulting in a higher quality molded part.

It should be noted that in any of the herein described embodiments, a plunger need not be used to hold the molten material in the melt zone, although it may be illustrated in the Figures. That is, in accordance with some embodiments, at least the first induction source is configured to restrict an opposite side (previously referred to as the plunger insertion side) of the ejection path of the vessel and contain the material in a molten form within the vessel during melting. In another embodiment, the first and the second induction sources can be used to contain the material on the opposite side of the vessel (e.g., see FIG. 5). Thus, the use of two or more induction sources in the manners described herein can also be used to remove a need for mechanical constraint on either side of the melt (i.e., no plunger or gate).

Accordingly, by implementing multiple induction sources such as disclosed in any of the embodiments herein, the melting process of materials, such as amorphous metals, in horizontal injection molding machines can be improved.

In applications where resistive heating of the coil is significant enough to soften or melt the coil material, some form of coil cooling should be employed. Thus, in addition to the features described above, any of the induction coils as disclosed in the embodiments herein may be configured to be associated a cooling system or cooling lines (e.g., see FIG. 5). That is, the same or a separate cooling system may be used to cool each of the induction coils and/or sources during heating or use of the system. The cooling system is configured to provide a cooling material, liquid, fluid, or gas to one or more parts of the system, which may be the induction coils themselves. The cooling can be “active” where a fluid or gas is used to carry the heat away from the coil material. In accordance with an embodiment, the gas or fluid is pumped through a coil which is formed out of a tube, or around part of a coil so that the heat is dissipated along the coil to the points which are actively cooled.

In either case, the cooling fluid or gas is provided at a temperature such that the energy (in the form of heat) is transferred from the coil material to the cooling fluid or gas, and carried downstream or away from the coil where heat energy is removed from the fluid or gas via a chilling unit and returned to the coil (closed loop system), or the liquid or gas is allowed to flow out into atmosphere, ground, holding tank, etc. (open loop system).

The cooling fluid can be selectively activated to run or pump through cooling lines. In some embodiments, the fluid or gas could be pumped through or adjacent the coils only while the induction sources are activated (i.e., receiving current for heating). In some embodiments, the fluid or gas can be configured to be pumped in order to sufficiently keep the coils at a safe operating temperature. For example, the system can be programmed to provide fluid or gas to the cooling lines/system based on sensor readings.

The dimensions of the induction sources and system parts described herein should not be limited. Also, each of the induction sources need not be of similar shape or size, or limited the drawings. For example, each coil or set of coils may be configured to be of the same size and diameter. Alternatively, each set of coils may comprise any number of coils (the same or different from an adjacent set) and/or any size of coils (the same or different from another set).

Although materials for devices may have been previously mentioned, it should be noted that the materials used to form any device, including coatings and/or a combination of materials, are exemplary only and not meant to be limiting. Any number of materials may be used to form the parts of the machine, including, but not limited to stainless steel (SS), copper, copper beryllium, amcolloy, ceramic, sialon ceramic, yttria, zirconia, chrome, titanium, silver, and stabilized ceramic.

It should also be noted that, although illustrated in some of the embodiments as such, the coils do not necessarily have to be of a tubular configuration. Rather, in accordance with one or more embodiments, the coils may have a solid core configuration (e.g., where the coils do not require fluid or gas cooling).

The coil leads or ends as shown in the embodiments are configured to be attached to a power source such as power source 28, so that power can be applied to the coils to melt the material received in vessels. In an embodiment, they may be powered by separate power sources. In another embodiment, each coil is configured to be powered separately. This can include powering individual sets of coils, or each coil in a set, for example.

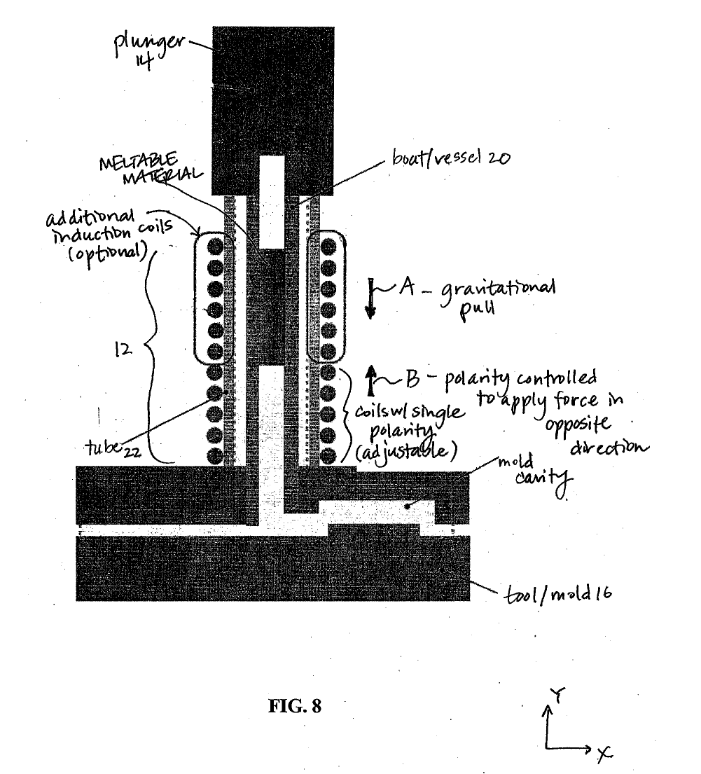

In another embodiment, it is envisioned that a single polarity (e.g., with an opposite one therebetween) can be used during the melting process to constrain the material during melting. That is, at least a first induction source (coils) may be positioned such that it is configured to be run at a polarity to constrain the material being melted by an inductive field within the vessel during melting. For example, such a coil may be used in a vertical melting and injection system, such as shown in FIG. 8, or a horizontal system. In such an embodiment, one can calculate an affect of gravity on the melt (gravity in a gravitational or a vertical direction, e.g., as indicated by arrow A in FIG. 8) and use such features for assembling the apparatus and the heating sources (e.g., induction sources). Assuming the plunger is applying force in the same direction as gravity (e.g., downwardly in a direction as indicated by arrow A), at least a single coil at a specific polarity can be used to apply force in an opposite or different direction than the plunger and/or gravity (as it pushes or pulls down)(e.g., in an opposite upward direction, as indicated by arrow B in FIG. 8). For example, a magnetic field could be fixed such that it applies a force on the melt to move towards the plunger (e.g., upwardly in FIG. 8). In this case, any form of heating may be superimposed on top of that, e.g., induction or any type of heating in the form of a second coil. In order to move material in such a device, a different frequency from the frequency used for AC magnetic push can be implemented via the one or more coils. For example, in an embodiment, the coils of the at least first induction source are configured to sequentially receive power such that the material in a molten form is moved through an ejection path of the vessel after melting, and into a mold for molding into a part. In one embodiment, such as shown in the Figure, another unsynchronized polarity from another source can be provided between the single polarity that is used to restrict the plunger/gravity force, for example, to assist in melting. However, two coiled induction sources need not be used.

While the principles of the disclosure have been made clear in the illustrative embodiments set forth above, it will be apparent to those skilled in the art that various modifications may be made to the structure, arrangement, proportion, elements, materials, and components used in the practice of the disclosure.

It will be appreciated that many of the above-disclosed and other features and functions, or alternatives thereof, may be desirably combined into many other different systems/devices or applications. Various presently unforeseen or unanticipated alternatives, modifications, variations, or improvements therein may be subsequently made by those skilled in the art which are also intended to be encompassed by the following claims.

What is claimed is:

1. An apparatus comprising:
a vessel for receiving meltable material;
a first induction source that is positioned adjacent the vessel and configured to melt the material received in the vessel, and
a second induction source that is positioned adjacent the vessel and configured to melt the material received in the vessel,
wherein both of the first induction source and the second induction source comprise coils that are configured to be run at unsynchronized polarities to constrain the material being melted by an inductive field formed from the first and second induction sources during melting.

2. The apparatus according to claim 1, further comprising a plunger configured to restrict an opposite side of the ejection path of the vessel and contain the material in a molten form within the vessel during melting of the material and further configured to move the material in a molten form through an ejection path of the vessel after melting.

3. The apparatus according to claim 2, further comprising a mold configured to receive the material in molten form from the ejection path of the vessel and to mold the material into a molded part.

4. The apparatus according to claim 1, wherein the first induction source and the second induction source are further configured to restrict material in its molten form from exiting an ejection path of the vessel during melting.

5. The apparatus according to claim 4, wherein the first induction source and the second induction source are further configured to restrict an opposite side of an ejection path of the vessel and contain the material in a molten form within the vessel during melting.

6. The apparatus according to claim 1, wherein the first induction source and the second induction source comprise coils that are further configured to sequentially receive power such that the material in a molten form is moved through an ejection path of the vessel after melting.

7. The apparatus according to claim 1, wherein the vessel is positioned along a horizontal axis such that movement of the material in a horizontal direction through an ejection path of vessel is restricted.

8. The apparatus according to claim 1, wherein the material to be melted is an amorphous alloy.

9. An apparatus comprising:
a vessel for receiving meltable material;
a first induction source that is positioned adjacent the vessel and configured to melt the material received in the vessel, and
a second induction source that is positioned adjacent the first induction source and adjacent an ejection path of the vessel, at least the second induction source configured contain the material in a molten form within the vessel during melting of the material.

10. The apparatus according to claim 9, further comprising a plunger configured to restrict an opposite side of the ejection path of the vessel and contain the material in a molten form within the vessel during melting of the material and further configured to move the material in a molten form through the ejection path after melting.

11. The apparatus according to claim 10, further comprising a mold configured to receive the material in molten form from the ejection path of the vessel and to mold the material into a molded part.

12. The apparatus according to claim 9, wherein at least the first induction source is further configured to restrict an opposite side of the ejection path of the vessel and contain the material in a molten form within the vessel during melting.

13. The apparatus according to claim 9, wherein the first induction source and the second induction source are further configured to sequentially receive power such that the material in a molten form is moved through the ejection path of the vessel after melting.

14. The apparatus according to claim 9, wherein the vessel is positioned along a horizontal axis such that the ejection path is in a horizontal direction.

15. The apparatus according to claim 9, wherein the material to be melted is an amorphous alloy.

16. A method of melting a material in a meltable form comprising:
providing an apparatus comprising a vessel for receiving meltable material;
providing a material to be melted within the vessel;
providing a first induction source positioned adjacent the vessel and configured to melt the provided material within in the vessel,
providing a second induction source is positioned adjacent the first induction source and adjacent an ejection path of the vessel;
applying a vacuum to the apparatus;
melting the material under vacuum by applying power to the first induction source; and
applying power to at least the second induction source during the melting of the material to contain the material in a molten form within the vessel during the melting of the material.

17. The method according to claim 16, wherein the apparatus further comprises a plunger, and the method further comprising: providing the plunger; positioning the plunger to restrict an opposite side of the ejection path of the vessel and contain the material in a molten form within the vessel during the melting of the material.

18. The method according to claim 17, wherein the method further comprises: moving the plunger from the opposite side and through the vessel to move the material in a molten form through the ejection path after melting.

19. The method according to claim 18, wherein the apparatus further comprises a mold, and wherein the method further comprises molding the material after melting, the method further comprising: providing the mold, the mold being configured to receive the material in molten form from the ejection path of the vessel, receiving in the mold via moving of the plunger the material in molten form, and molding the material into a molded part using the mold.

20. The method according to claim 16, wherein at least the first induction source is further configured to restrict an opposite side of the ejection path of the vessel and contain the material in a molten form within the vessel during melting.

21. The method according to claim 16, wherein the method further comprises sequentially powering the first induction source and the second induction source such that the material in a molten form is moved through an ejection path of the vessel after melting.

22. The method according to claim 16, wherein the vessel is positioned along a horizontal axis such that the ejection path is in a horizontal direction, and wherein the method comprises providing the vessel along the horizontal axis and melting the material in the vessel along the horizontal axis.

23. The method according to claim 16, wherein the material to be melted is an amorphous alloy.

24. A method of moving material in a molten form comprising:
providing an apparatus comprising a vessel for receiving meltable material;
providing a material to be melted within the vessel;
providing a first induction source positioned adjacent the vessel and configured to melt the provided material within in the vessel,
providing a second induction source is positioned adjacent the first induction source and adjacent an ejection path of the vessel;
applying a vacuum to the apparatus;
melting the material under vacuum by applying power to at least the first induction source; and
sequentially applying power to either or both of the first induction source and the second induction source after the melting of the material to move the material in a molten form through the vessel and its ejection path.

25. The method according to claim 24, wherein each of the first induction source and the second induction source comprises a plurality of coils, each coil being configured to be powered separately, and wherein the sequentially applying power comprises sequentially powering each coil from the first induction source and, thereafter, sequentially powering each coil from the second induction source to move the material in molten form through the ejection path.

26. The method according to claim 24, wherein the vessel is positioned along a horizontal axis such that the ejection path is in a horizontal direction, and wherein the method comprises: providing the vessel along the horizontal axis, melting the material in the vessel along the horizontal axis, and sequentially applying power such that the material moves along the horizontal axis and through the ejection path of the vessel.

27. The method according to claim 24, wherein the method further comprises applying power to the second induction source during the melting of the material to contain the material in a molten form within the vessel during the melting of the material before sequentially applying power to move the material in a molten form.

28. An apparatus comprising:
a vessel for receiving meltable material;
at least a first induction source that is positioned adjacent the vessel and configured to melt the material received in the vessel,
wherein at least the first induction source comprise coils that are configured to be run at a polarity to constrain the material being melted by an inductive field within the vessel during melting.

29. The apparatus according to claim 28, further comprising a plunger configured to restrict an opposite side of the vessel and contain the material in a molten form within the vessel during melting of the material and further configured to move the material in a molten form through an ejection path of the vessel after melting.

30. The apparatus according to claim 29, further comprising a mold configured to receive the material in molten form from the ejection path of the vessel and to mold the material into a molded part.

31. The apparatus according to claim 28, wherein the at least first induction source is configured to restrict material in its molten form from exiting an ejection path of the vessel during melting in a direction opposite to a gravitational direction.

32. The apparatus according to claim 28, wherein the at least first induction source comprises coils that are further configured to sequentially receive power such that the material in a molten form is moved through an ejection path of the vessel after melting.

33. The apparatus according to claim 28, wherein the vessel is positioned along a vertical axis such that movement of the material in a vertical direction through an ejection path of vessel is restricted.
